(19) United States
(12) Patent Application Publication
(10) Pub. No.: US 2014/0044472 A1
(43) Pub. Date: Feb. 13, 2014

(54) PIVOT JOINT FOR A BABY CARRIER

(71) Applicant: LERADO (ZHONG SHAN) INDUSTRIAL CO., LTD., ZHONG SHAN CITY (CN)

(72) Inventors: YUNG-SHUEN LIN, TAIBAO CITY (TW); SHAN-HENG LIN, ZHONGPU TOWNSHIP (TW)

(73) Assignee: LERADO (ZHONG SHAN) INDUSTRIAL CO., LTD., ZHONG SHAN CITY (CN)

(21) Appl. No.: 13/965,765

(22) Filed: Aug. 13, 2013

(30) Foreign Application Priority Data
Aug. 13, 2012 (CN) 201220398312.9

(51) Int. Cl. B62B 7/06; F16C 11/10

(52) U.S. Cl. CPC B62B 7/06; F16C 11/10
USPC 403/92

(57) ABSTRACT

A pivot joint for a baby carrier for locking a baby carrier in an in-use configuration and convertible into a foldable condition, includes a first pivot part, a second pivot part, a locking mechanism, a release mechanism and a retaining mechanism. The first pivot part and the second pivot part are pivotally connected between a first support member and a second support member of the baby carrier. The locking mechanism comprises a latch element operatively mounted inside the first pivot part and can be driven to a latched position to engage with the second pivot part and a released position to disengage from the second pivot part. The release mechanism is associated with the latch element for moving the latch element from the latched position to the released position. The retaining mechanism is mounted inside the first pivot part for engaging and retaining the latch element in the released position.

### BACKGROUND OF THE INVENTION

1. Field of the Invention

The present invention relates to a pivot joint for locking a baby carrier in an in-use configuration, especially to a pivot joint capable of retaining in a release condition when being unlocked the baby carrier from the in-use configuration,

2. Description of the Related Art

Some of traditional baby carriers such as baby stroller, high chair, bouncer and rock chair are foldable by using a pivot joint to lock two support member thereof in an in-use configuration, and releasable to a foldable condition for converting the baby carrier into a compact configuration for easy transport and storage.

The pivot joint is unlocked by manipulating a release actuator to pull a latch element against a spring biasing force. When user's hand left the release actuator, the latch element would lock the pivot joint immediately and automatically due to the biasing force of the spring. This would disturb the folding operation of baby carriers.

### SUMMARY OF THE INVENTION

For improving the pivot joint and avoiding the unwanted automatic locking after a user manipulated the release actuator, the present invention provides a pivot joint for locking the baby carrier in an in-use configuration and capable of converting the baby carrier into a foldable condition by unlocking the pivot joint.

The pivot joint according to the present invention includes a first pivot part, a second pivot part, a locking mechanism, a release mechanism and a retaining mechanism. The first pivot part and the second pivot part are pivot with each other by a shaft and connected between a first support member and a second support member of the baby carrier.

The locking mechanism comprises a latch element operatively mounted inside the first pivot part and can be driven to a latched position to engage with the second pivot part and a released position to disengage from the second pivot part. The release mechanism is associated with the latch element for moving the latch element from the latched position to the released position.

The retaining mechanism is mounted inside the first pivot part for engaging and retaining the latch element in the released position. By this way, would prevent the moving of the latch element from disturbing the folding operation of the baby carriers.

### BRIEF DESCRIPTION OF THE DRAWINGS

The accompanying drawings, which are included to provide a further understanding of the invention are incorporated in and constitute a part of this specification, illustrated embodiments of the invention and together with the description serve to explain the principles of the invention. In the drawings:

FIG. 1 is a perspective view schematically showing an embodiment of the pivot joint according to the present invention mounted on a baby carrier, such as a baby stroller frame.

FIG. 2 is an exploded perspective view of e pivot joint and two support members of the baby carrier.

FIG. 3 is a perspective view schematically showing the pivot joint locked the two support members of the baby carrier in an in-use configuration.

FIG. 4 is a cross-sectional view schematically showing the pivot joint being locked the two support members of the baby carrier in the in-use configuration.

FIG. 5 is a cross-sectional view schematically showing the pivot joint being unlocked by disengaging a latch element from the second pivot part.

FIG. 6 is a cross-sectional view schematically showing the latch element being retained in a released position.

FIG. 7 is a cross-sectional view schematically showing the latch element being retained in a released position and the two support members of the baby carrier being rotated to a folded position.

### DETAILED DESCRIPTION OF THE PREFERRED EMBODIMENTS

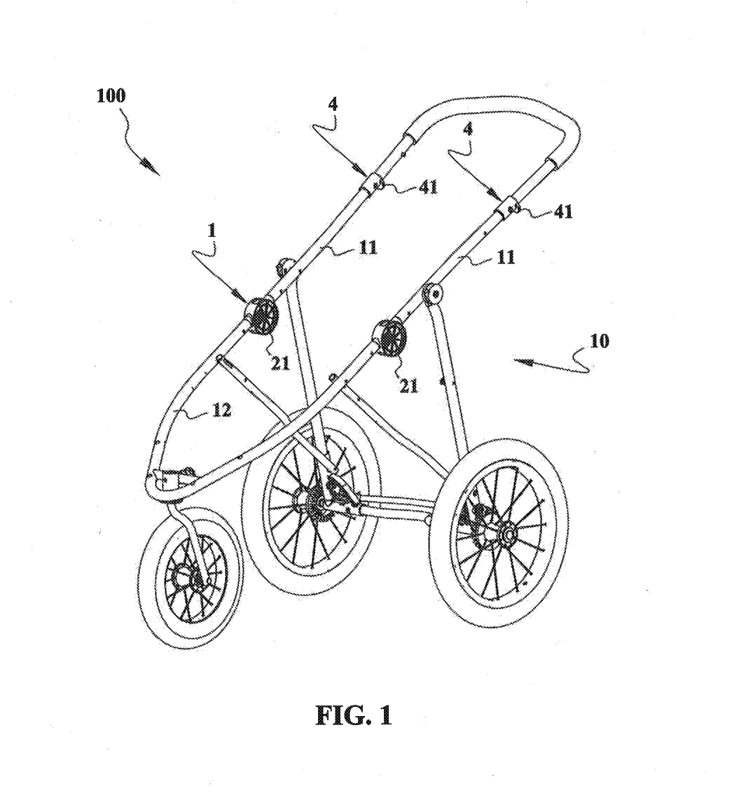

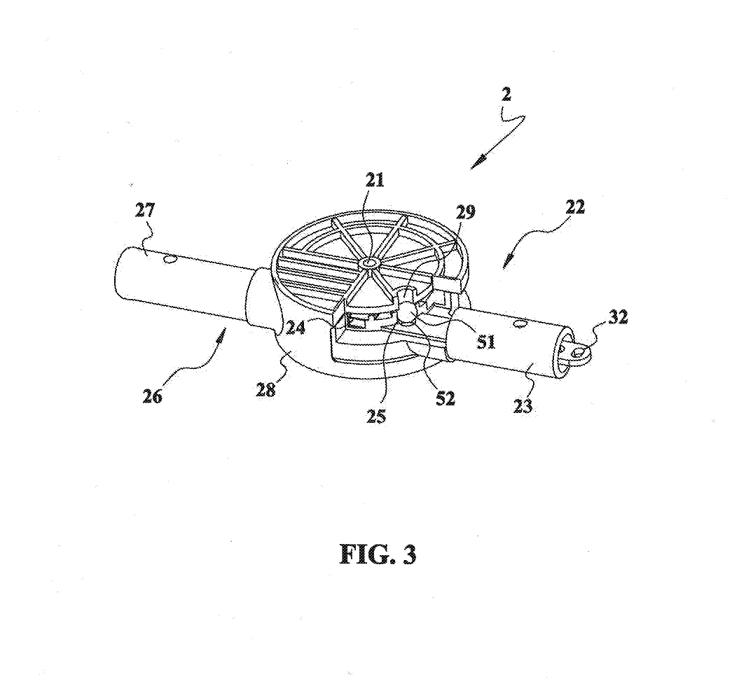

Referring to FIGS. 1 to 3, a pivot joint 2 according to the present invention is embodied to use for lockably pivoting a first support member 11 and a second support member 12 of a baby carrier 10 at a pivot point 1 thereby locking the baby carrier 10 in an in-use configuration 100 and releasing the baby carrier 10 into a foldable condition.

The pivot joint 2 of the present embodiment includes a first pivot part 22, a second pivot part 26, a locking mechanism 3, a release mechanism 4 and a retaining mechanism 5.

The first pivot part 22 has one end connected with the first support member 11. For instance, the first pivot part 22 may include a first extension 23 formed integrally with a first plate 24 and featured by having a through slot 20 formed within the first plate 24 for slidably mounting the latch element 32 therein, and a cavity 25 extended from one side of the through slot 20 for installing the retaining mechanism 5.

The second pivot part 26 has one end connected with the second support member 12, and another end pivoted with the first pivot part 22. The second pivot part 26 of this embodiment includes a second extension 27 formed integrally with two second plates 28 for pivoting the first plate 24 therebetween by a shaft 21, and formed a slot 31 for engaging with the latch element 32 when the latch element 32 is moved to the latched position 34 so as to lock the baby carrier 10 in the in-use configuration 100.

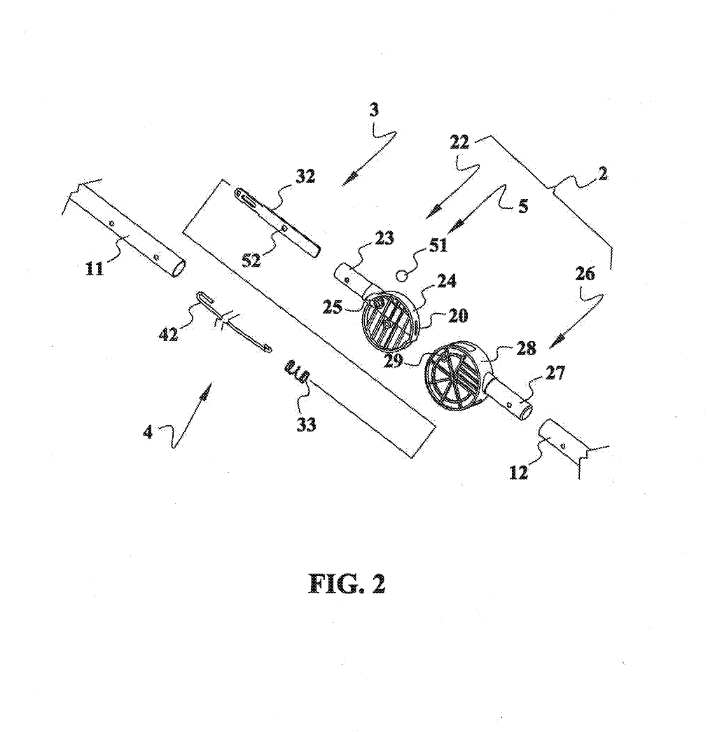

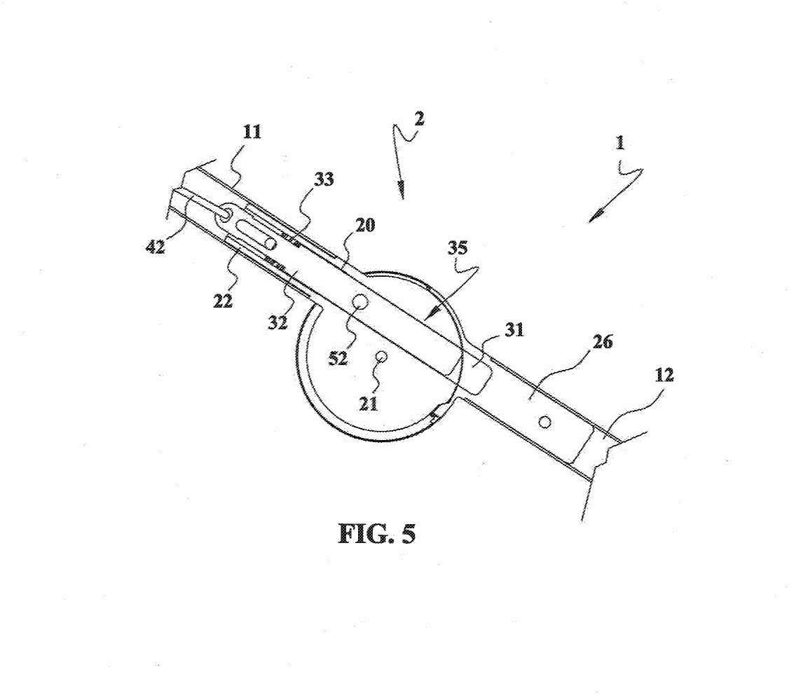

The retaining mechanism 5 is mounted inside the first pivot part 22 for engaging and retaining the latch element 32 in the released position 35. Referring to FIGS. 2 to 7, the retaining mechanism 5 may include a ball 51, and one of the second plates is formed with a hole 29 relative to the cavity 25 so as to permit the ball 51 of the latch element 32 to be received, within a space formed by the hole 29 and the cavity 25 when the pivot joint 2 is locked the baby carrier 10 in the in-use configuration 100.

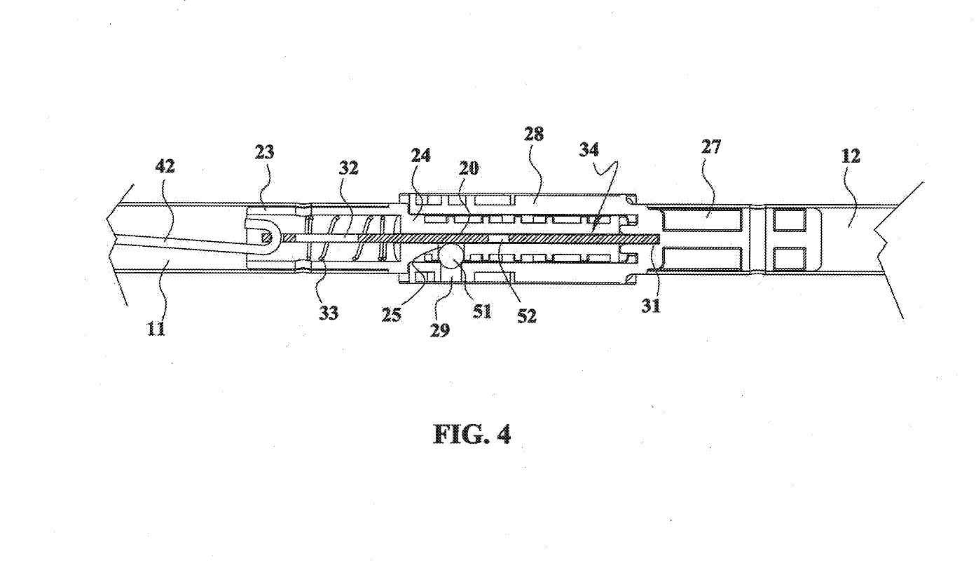

The locking mechanism 3 comprises a latch element 32 operatively mounted inside the first pivot part 22. Referring to FIG. 4, the latch element 32 can be driven into a latched position 34 to engage with the second pivot part 26 and a released position 35 to disengage from the second pivot part 26. Preferably, the latch element 32 may be biased by a resilient element 33 toward the latched position 34 so as to automatically lock the baby carrier 10 in the in-use configuration 100.

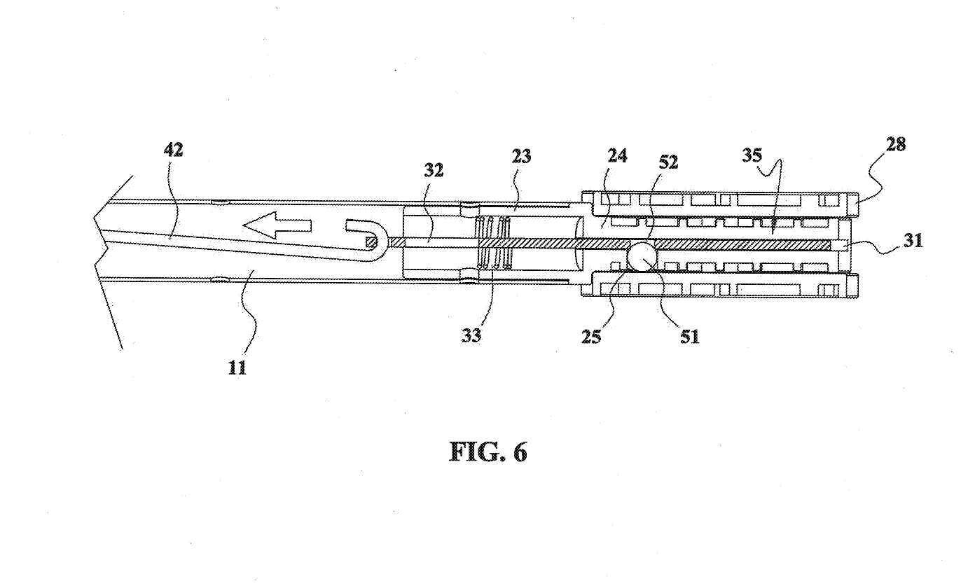

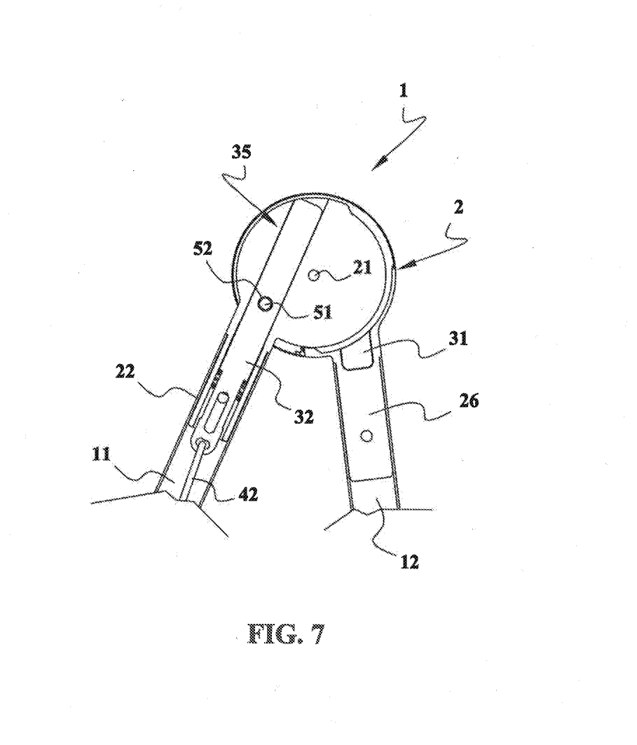

The latch element 32 is formed with an engagable portion 52 for engaging with the ball 51 of the retaining mechanism 5. The ball 51 is engaged with the engagable portion 52 for retaining the latch element 32 in the released position 35 as shown in FIGS. 6 and 7.

The release mechanism 4 is associated with the latch element 32 for moving the latch element 32 from the latched position 34 to the released position 35.

Referring to FIGS. 1 and 2, the release mechanism 4 includes a remote release actuator 41 and an associating element 42.

The remote release actuator 41 is operatively mounted on the first support member 11 and associated with the latch element 32. The associating element 42 is connected between the remote release actuator 41 and the latch element 32 and capable of driving the latch element 32 from the latched position 34 to the released position 35 by operation of the remote release actuator 41.

The remote release actuator 41 is a slidable element movable alone the first support member 11. For instance, the remote release actuator 41 may be embodied as a single or two bushings slidably mounted on the first support member 11 and associated with two latch elements 32 which mounted on both sides of the baby carrier 10 via two associating elements 42 respectively.

When user's hand left the release actuator after being operated the remote release actuator 41, the retaining mechanism 5 would retain the latch element 32 in the released position 35 automatically. This would prevent the biasing of the resilient element 33 on the latch element 32 from disturbing the folding operation of the baby carriers.

While particular embodiments of the invention have been described, those skilled in the art will recognize that many modifications are possible that will achieve the same goals by substantially the same system, device or method, and where those systems, devices or methods still fall within the true spirit and scope of the invention disclosed.

What is claimed is:

1. A pivot joint for a baby carrier, for lockably pivoting a first support member (11) and a second support member (12) of the baby carrier (10) at a pivot point (1), capable of locking the baby carrier (10) in an in-use configuration (100) and releasing the baby carrier (10) into a foldable condition, the pivot joint (2) including:
a first pivot part (22), having one end connected with the first support member (11);
a second pivot part (26), having one end connected with the second support member (12), and another end pivoted with the first pivot part (22);
a locking mechanism (3), comprising a latch element (32) operatively mounted inside the first pivot part (22), wherein the latch element (32) can be driven to a latched position (34) to engage with the second pivot part (26) and a released position (35) to disengage from the second pivot part (26);
a release mechanism (4), associated with the latch element (32) for moving the latch element (32) from the latched position (34) to the released position (35); and
a retaining mechanism (5), mounted inside the first pivot part (22) for engaging and retaining the latch element (32) in the released position (35),

2. The pivot joint for a baby carrier according to claim 1, wherein the latch element (32) is biased by a resilient element (33) toward the latched position (34) thereby automatically locking the baby carrier (10) in the in-use configuration (100).

3. The pivot joint for a baby carrier according to claim 1, wherein the release mechanism (4) includes:
a remote release actuator (41), operatively mounted on the first support member (11) and associated with the latch element (32); and
an associating element (42) connected between the remote release actuator (41) and the latch element (32) and capable of driving the latch element (32) from the latched position (34) to the released position (35) by operation of the remote release actuator (41).

4. The pivot joint for a baby carrier according to claim 1, wherein the remote release actuator (41) is a slidable element movable alone the first support member (11).

5. The pivot joint for a baby carrier according to claim 1, wherein the remote release actuator (41) is associated with two latch elements (32) mounted on two sides of the baby carrier (10) via two associating elements (42) respectively.

6. The pivot joint for a baby carrier according to claim 1, wherein the first pivot part (22) includes a first extension (23) formed integrally with a first plate (24) and featured by having a through slot (20) formed within the first plate (24) for slidably mounting the latch element (32) therein, and a cavity (25) extended from one side of the through slot (20) for installing the retaining mechanism (5).

7. The pivot joint for a baby carrier according to claim 6, wherein the second pivot part (26) includes a second extension (27) formed integrally with two second plates (28) for pivoting the first plate (24) therebetween by a shaft (21), and formed a slot (31) for engaging with the latch element (32) when the latch element (32) is moved to the latched position (34) so as to lock the baby carrier (10) in the in-use configuration (100).

8. The pivot joint for a baby carrier according to claim 7, wherein the second pivot part (26) includes a second extension (27) formed integrally with two second plates (28) for pivoting the first plate (24) therebetween; wherein one of the second plates is featured by having a hole (29) relative to the cavity (25) so as to permit a ball (51) of the latch element (32) to be received within a space formed by the hole (29) and the cavity (25) when the pivot joint (2) is locked the baby carrier (10) in the in-use configuration (100).

9. The pivot joint for a baby carrier according to claim 8, wherein the latch element (32) is formed with an engagable portion (52) for engaging with the ball (51).

10. The pivot joint for a baby carrier according to claim 9, wherein the ball (51) is engaged with the engagable portion (52) for retaining the latch element (32) in the released position (35).
